(19) United States
(12) Patent Application Publication
(10) Pub. No.: US 2009/0271246 A1
(43) Pub. Date: Oct. 29, 2009

(54) MERCHANT RECOMMENDATION SYSTEM AND METHOD

(75) Inventors: Eduardo J. Alvarez, Princeton, NJ (US); Priyo B. Chatterjee, Jersey City, NJ (US); Rachel Garrett, Brooklyn, NY (US); Jeffrey J. Harouche, Great Neck, NJ (US); Wonmoh A. Lee, Fort Lee, NJ (US); Serguei Nikiforov, Forest Hills, NY (US); Oguz S. Ozsahin, Lyndhurst, NJ (US); Jason Santos, River Edge, NJ (US); Prashant K. Sinha, East Brunswick, NJ (US); Deep Thomas, East Brunswick, NJ (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: AMERICAN EXPRESS TRAVEL RELATED SERVICES COMPANY, INC., New York, NY (US)

(21) Appl. No.: 12/110,822

(22) Filed: Apr. 28, 2008

(51) Int. Cl. G06Q 20/00

(52) U.S. Cl. 705/10

(57) ABSTRACT

Automated generation of a merchant recommendation list is disclosed. When a financial processor obtains rich and relevant information related to consumers and merchants, collaborative filtering, profiling, clustering and predictive modeling techniques are combined to provide merchant recommendations to a consumer. The system analyzes consumer attributes which relate to target consumer attributes to create a target consumer cluster, creates associations based upon merchant attributes and the target consumer attributes and provides the feedback based on the associations.

### FIELD OF THE INVENTION

The present invention generally relates to using analytics and strategic marketing methods to develop feedback, and more particularly, to applying techniques such as collaborative filtering, profiling, clustering and predictive modeling to data accessible to a transaction account issuer in order to provide merchant recommendations.

### BACKGROUND OF THE INVENTION

With the explosion of e-commerce, a vast amount of data exists that relates to online activity, indication of interest in an item (e.g. product viewed or clicked on), rating of items and review of items. Organizations often generate recommendation lists for consumers in order to improve satisfaction and drive revenues. However, though voluminous, not all the data collected about consumers and consumer activity is relevant to providing valuable recommendations. Therefore, one of the biggest challenges faced by organizations desiring to provide consumers is identifying which data is most relevant to a target consumer's preferences.

Recommendation algorithms usually use input about a consumer's interests to generate a list of recommended items. Recommendation methods typically use limited sources of data in generating recommendations for consumers, so while the data may be deep (e.g. a large amount of data) it is often narrow (i.e. only provides insight into certain consumer attributes). For instance, popular online e-commerce web sites often use only the items that consumers purchase and explicitly rate to analyze what items a consumer might be interested in reviewing or purchasing. Some recommendation systems also use other attributes in formulating recommendations, including items that were viewed on a web page, demographic data, subject interests, and other user profile information.

Common methods implemented to provide recommendations include collaborative filtering, clustering and search-based methods. Collaborative filtering includes using techniques based on collaboration among multiple agents, viewpoints, data sources, and the like to filter large amounts of information. Clustering includes the classification of data into different groups so that the data in each group share some common trait. Cluster models are often based upon a metric or distance function used to measure the distance (e.g. relatedness) of the members in a set. Search based methods includes recommendations based on the content of a search by recommending items that are associated with the same or similar search keywords.

Using relevant data, recommendation methods typically provide an effective form of targeted marketing by creating a shopping experience that is personalized and relevant to the consumer. However, current recommendation systems often have limited access to a unique set of data that provides a holistic view of a consumer's spending habits and preferences. For instance, online retailer Amazon may have information regarding the products purchased by a particular consumer on their e-commerce site, but they lack the information on the type of products and services the same consumer purchases from other merchants. Therefore, a long-felt need exists for a method to leverage the large amount of data available to some financial processors to provide an enhanced recommendation system.

### SUMMARY OF THE INVENTION

The present invention improves upon existing systems and methods by providing a tangible, integrated, end-to-end analysis and recommendation method. The data accessible to a financial processor is leveraged using sophisticated data clustering and collaborative filtering techniques. Associations are established among consumers, and between consumers and merchants, to formulate merchant recommendations for a target consumer.

In one embodiment, the method incorporates data from multiple data sources to generate useful recommendations for a target consumer. The process includes analyzing consumer attributes which relate to target consumer attributes to create a target consumer cluster, creating associations based upon merchant attributes and target consumer attributes and providing the feedback based on the associations.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an overview of a representative system for providin g feedback to a consumer, in accordance with one embodiment of the present invention.

FIG. 2 is a representative process flow diagram for generating a recommendation list and presenting it to a consumer, in accordance with one embodiment of the present invention.

FIG. 3 is a representative process flow diagram for computing restaurant relevancy scores, in accordance with one embodiment of the present invention.

### DETAILED DESCRIPTION OF EXEMPLARY EMBODIMENTS

The detailed description of exemplary embodiments of the invention herein makes reference to the accompanying drawings, which show the exemplary embodiment for purposes of illustration and its best mode, and not of limitation. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process descriptions may be executed in any order and are not limited to the order presented. References to singular include plural, and references to plural include singular.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a graphical user interface (GUI), a software module, logic engines, databases and computer networks. While the system may contemplate upgrades or reconfigurations of existing processing systems, changes to existing databases and business information system tools are not necessarily required by the present invention.

The exemplary benefits provided by the representative embodiments include increased consumer loyalty, increased consumer satisfaction and increased merchant satisfaction. For example, financial processors take advantage of valuable data to deliver enhanced service by providing recommendation lists to transaction account consumers. This enhanced service improves consumer loyalty and drives transaction account spending. Furthermore, merchant loyalty and satisfaction is enhanced by the increased revenue resulting suggestions to patronize their products and/or services.

While described in the context of systems and methods that enable providing restaurant recommendations, practitioners will appreciate that certain embodiments may be similarly used to enhance functionality, improve consumer satisfaction and loyalty, and increase recommendation accuracy in the context of providing feedback, observations or recommendations for any product or service. For example, in one embodiment, the recommendation techniques involve analysis of complimentary and/or mutually exclusive products. In one embodiment, analysis of a particular product group (e.g. restaurant services) is used to make recommendations for a different product group (e.g. day care services). Other embodiments of such recommendation techniques may be accomplished through a variety of computing resources and hardware infrastructures.

While the description makes reference to specific technologies, system architectures and data management techniques, practitioners will appreciate that this description is but one embodiment and that other devices and/or methods may be implemented without departing from the scope of the invention. Similarly, while the description makes frequent reference to a web client, practitioners will appreciate that other examples of communicating recommendations, presenting data, gathering feedback and the like may be accomplished by using a variety of user interfaces including handheld devices such as personal digital assistants and cellular telephones. Furthermore, other communication and consumer interface methods such as direct mail, email, consumer invoices and targeted marketing may also be used to provide recommendations to the consumer without departing from the present invention.

“Entity” may include any individual, consumer, customer, group, business, organization, government entity, transaction account issuer or processor (e.g., credit, charge, etc), merchant, consortium of merchants, account holder, charitable organization, software, hardware, and/or any other entity.

An “account”, “account number” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account number may be, for example, any number or alpha-numeric characters that identify a particular merchant for purposes of card acceptance, account reconciliation, reporting, or the like.

A “transaction account” (“TXA”) includes any account that may be used to facilitate a financial transaction. A “TXA issuer” includes any entity that offers TXA services to customers.

A “consumer” includes any software, hardware, and/or entity that consumes products or services.

A “target consumer” includes any consumer for which a recommendation list is being analyzed or generated.

A “merchant” includes any software, hardware and/or entity that receives payment or other consideration, provides a product or a service or otherwise interacts with a consumer. For example, a merchant may request payment for services rendered from a consumer who holds an account with a TXA issuer.

A “restaurant” includes any merchant whose product and/or services involve providing food, distributing food, providing food services and the like.

A “financial processor” may include any entity which processes information or transactions, issues accounts, acquires financial information, settles accounts, conducts dispute resolution regarding accounts, and/or the like.

A “trade” or “tradeline” includes a credit or charge vehicle typically issued to an individual consumer by a credit grantor. Types of tradelines include, for example, bank loans, TXAs, personal lines of credit and car loans/leases. Credit bureau data includes any data retained by a credit bureau pertaining to a particular consumer. A credit bureau is any organization that collects and/or distributes consumer data. A credit bureau may be a consumer reporting agency. Credit bureaus generally collect financial information pertaining to consumers. Credit bureau data may include consumer account data, credit limits, balances, and payment history. Credit bureau data may include credit bureau scores that reflect a consumer's creditworthiness. Credit bureau scores are developed from data available in a consumer's file, such as the amount of lines of credit, payment performance, balance, and number of tradelines. This data is used to model the risk of a consumer over a period of time using statistical regression analysis. In one embodiment, those data elements that are found to be indicative of risk are weighted and combined to determine the credit score. For example, each data element may be given a score, with the final credit score being the sum of the data element scores.

A “user” 105 may include any individual or entity that interacts with system 101. User 105 may perform tasks such as requesting, retrieving, updating, analyzing, entering and/or modifying data. User 105 may be, for example, a consumer accessing a TXA issuer's online portal and viewing a bill that includes restaurant recommendations. User 105 may interface with Internet server 125 via any communication protocol, device or method discussed herein, known in the art, or later developed. In one embodiment, user 105 may interact with RMIS 115 via an Internet browser at a web client 110.

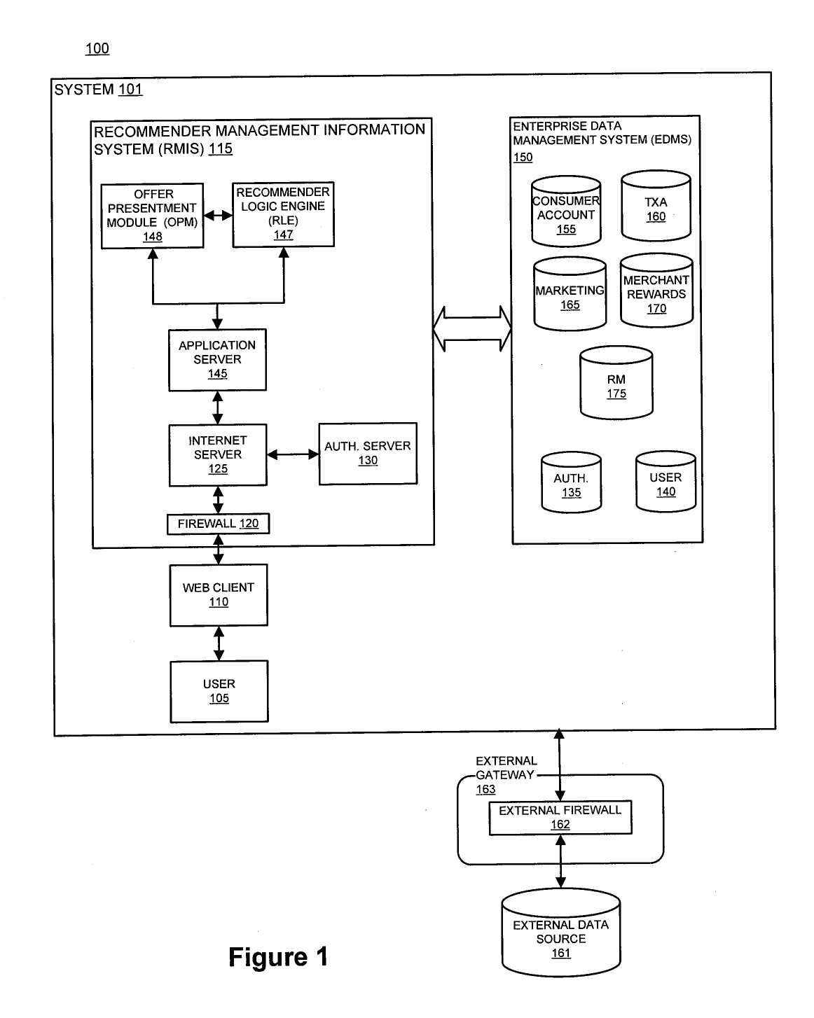

With reference to FIG. 1, the system includes a user 105 interfacing with a recommender management information system (“RMIS”) 115 by way of a web client 110. Web client 110 comprises any hardware and/or software suitably configured to facilitate requesting, retrieving, updating, analyzing, entering and/or modifying data. The data may include recommendation data or any information discussed herein. Web client 110 includes any device (e.g., personal computer), which communicates (in any manner discussed herein) with the RMIS 115 via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers and/or the like. Practitioners will appreciate that the web client 110 may or may not be in direct contact with the RMIS 115. For example, the web client 110 may access the services of the RMIS 115 through another server, which may have a direct or indirect connection to Internet server 125.

The invention contemplates uses in association with billing systems, electronic presentment and payment systems, consumer portals, business intelligence systems, reporting systems, web services, pervasive and individualized solutions, open source, biometrics, mobility and wireless solutions, commodity computing, grid computing and/or mesh computing. For example, in an embodiment, the web client 110 is configured with a biometric security system that may be used for providing biometrics as a secondary form of identification. The biometric security system may include a transaction device and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

The user 105 may communicate with the RMIS 115 through a firewall 120 to help ensure the integrity of the RMIS 115 components. Internet server 125 may include any hardware and/or software suitably configured to facilitate communications between the web client 110 and one or more RMIS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within the authentication database 135 and the user database 140.

Application server 145 may include any hardware and/or software suitably configured to serve applications and data to a connected web client 110. The recommender logic engine 147 is configured to perform recommendation methods. The recommendation methods include, for example, collaborative filtering, clustering, profiling, forecasting and/or the like. Offer presentment module (“OPM”) 148 is configured to format, sort, report or otherwise manipulate data to prepare it for presentment to the user 105. Additionally, RLE 147 and OPM 148 may include any hardware and/or software suitably configured to receive requests from each other, the web client 110 via Internet server 125 and the application server 145. RLE 147 and OPM 148 are further configured to process requests, execute transactions, construct database queries, and/or execute queries against databases within enterprise data management system (“EDMS”) 150, other system 101 databases, external data sources and temporary databases, as well as exchange data with other application modules (not pictured in FIG. 1). In one embodiment, the RLE 147 and OPM 148 may be configured to interact with other system 101 components to perform complex calculations, retrieve additional data, format data into reports, create XML representations of data, construct markup language documents, and/or the like. Moreover, the RLE 147 and OPM 148 may reside as a standalone system or may be incorporated with the application server 145 or any other RMIS 115 component as program code.

FIG. 1 depicts databases that are included in an exemplary embodiment of the invention. A representative list of various databases used herein includes: an authentication database 135, a user database 140, a consumer account database 155, a TXA database 160, a marketing database 165, a merchant rewards database 170, a relationship management database 175, an external data source 161 and/or other databases that aid in the functioning of the system. As practitioners will appreciate, while depicted as a single entity for the purposes of illustration, databases residing within system 101 may represent multiple hardware, software, database, data structure and networking components. Authentication database 135 may store information used in the authentication process such as, for example, user identifiers, passwords, access privileges, user preferences, user statistics, and the like. The user database 140 maintains user information and credentials for RMIS 115 users. The consumer account database stores information on consumer transaction accounts such as consumer demographic information, authorized merchant information, rewards program information and any other information that enables making charges to a consumer transaction account and also enables sophisticated recommendation methods. The transaction TXA database 160 stores financial transactions. The marketing database 165 stores information regarding marketing and promotional programs. The merchant rewards database 170 stores information related to consumer rewards and incentive programs. The relationship management (“RM”) database 175 stores strategic information regarding current, past and present consumers. As practitioners will appreciate, embodiments are not limited to the exemplary databases described above, nor do embodiments necessarily utilize each of the disclosed exemplary databases.

In addition to the components described above, the system 101, the RMIS 115 and the EDMS 150 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

As those skilled in the art will appreciate, the web client 110 includes an operating system (e.g., Windows NT, 95/98/2000, OS2, UNIX, Linux, Solaris, MacOS, etc.) as well as various conventional support software and drivers typically associated with computers. Web client 110 may include any suitable personal computer, network computer, workstation, minicomputer, mainframe, mobile device or the like. Web client 110 can be in a home or business environment with access to a network. In an embodiment, access is through a network or the Internet through a commercially available web-browser software package. Web client 110 may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Firewall 120, as used herein, may comprise any hardware and/or software suitably configured to protect the RMIS 115 components from users of other networks. Firewall 120 may reside in varying configurations including stateful inspection, proxy based and packet filtering, among others. Firewall 120 may be integrated as software within Internet server 125, any other system components, or may reside within another computing device or may take the form of a standalone hardware component.

Internet server 125 may be configured to transmit data to the web client 110 within markup language documents. As used herein, “data” may include encompassing information such as commands, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Like Internet server 125, the application server 145 may communicate with any number of other servers, databases and/or components through any means known in the art. Further, the application server 145 may serve as a conduit between the web client 110 and the various systems and components of the RMIS 115. Internet server 125 may interface with the application server 145 through any means known in the art including a LAN/WAN, for example. Application server 145 may further invoke software modules such as the RLE 147 or the OPM 148 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (http://yahoo.com/stockquotes/ge) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Any database depicted or implied by FIG. 1, or any other database discussed herein, may include any hardware and/or software suitably configured to facilitate storing identification, authentication credentials, and/or user permissions. One skilled in the art will appreciate that system 101 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In an embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second parties. Each of the three data sets in this example may contain different information that is stored using different data storage formats and/or techniques. Further, each data set may contain subsets of data that also may be distinct from other subsets.

As stated above, in various embodiments of system 101, the data can be stored without regard to a common format. However, in one embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 101 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

The system 101 may be interconnected to an external data source 161 (for example, to obtain data from a vendor) via a second network, referred to as the external gateway 163. The external gateway 163 may include any hardware and/or software suitably configured to facilitate communications and/or process transactions between the system 101 and the external data source 161. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing either inside EDMS 150, the external data source 161 or any other known configuration. External gateway 163 may be configured to deliver data directly to system 101 components (such as RLE 147) and to interact with other systems and components such as EDMS 150 databases. In one embodiment, the external gateway 163 may comprise web services that are invoked to exchange data between the various disclosed systems. The external gateway 163 represents existing proprietary networks that presently accommodate data exchange for data such as financial transactions, consumer demographics, billing transactions and the like. The external gateway 163 is a closed network that is assumed to be secure from eavesdroppers.

The invention may be described herein in terms of functional block components, screen shots, optional selections and various processing steps. It should be appreciated that such functional blocks may be realized by any number of hardware and/or software components configured to perform the specified functions. For example, system 101 may employ various integrated circuit components, e.g., memory elements, processing elements, logic elements, look-up tables, and/or the like, which may carry out a variety of functions under the control of one or more microprocessors or other control devices. Similarly, the software elements of system 101 may be implemented with any programming or scripting language such as C, C++, Java, COBOL, assembler, PERL, Visual Basic, SQL Stored Procedures, extensible markup language (XML), cascading style sheets (CSS), extensible style sheet language (XSL), with the various algorithms being implemented with any combination of data structures, objects, processes, routines or other programming elements. Further, it should be noted that system 101 may employ any number of conventional techniques for data transmission, signaling, data processing, network control, and/or the like. Still further, system 101 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

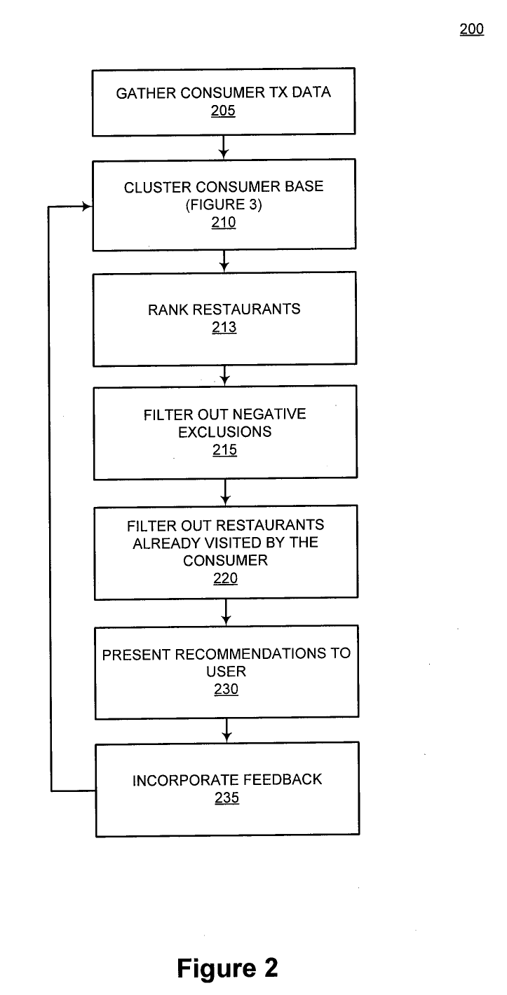

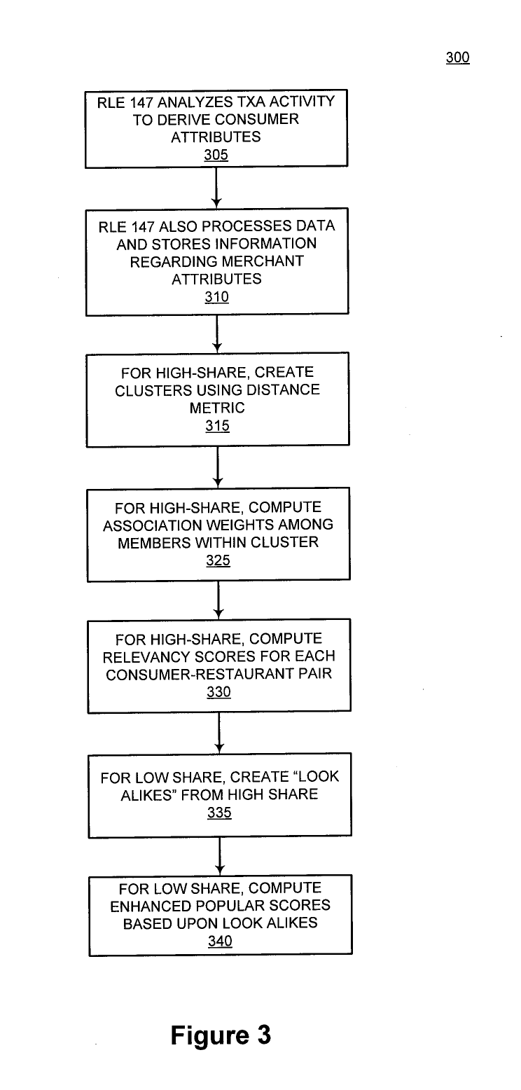

Referring now to the figures, the block system diagrams and process flow diagrams represent mere embodiments of the invention and are not intended to limit the scope of the invention as described herein. For example, the steps recited in FIGS. 2-3 may be executed in any order and are not limited to the order presented. It will be appreciated that the following description makes appropriate references not only to the steps depicted in FIGS. 2-3, but also to the various system components as described above with reference to FIG. 1.

With reference to FIG. 1, in one embodiment, when user 105 logs on to an application, Internet server 125 may invoke an application server 145. Application server 145 invokes logic in the RLE 147 and OPM 148 or other application by passing parameters relating to the user's 105 requests for data. The RMIS 115 manages requests for data from the applications and communicates with system 101 components. Transmissions between the user 105 and the Internet server 125 may pass through a firewall 120 to help ensure the integrity of the RMIS 115 components. Practitioners will appreciate that the invention may incorporate any number of security schemes or none at all. In one embodiment, the Internet server 125 receives page requests from the web client 110 and interacts with various other system 101 components to perform tasks related to requests from the web client 110. Internet server 125 may invoke an authentication server 130 to verify the identity of user 105 and assign specific access rights to user 105. In order to control access to the application server 145 or any other component of the RMIS 115, Internet server 125 may invoke an authentication server 130 in response to user 105 submissions of authentication credentials received at Internet server 125. When a request to access system 101 is received from Internet server 125, Internet server 125 determines if authentication is required and transmits a prompt to the web client 110. User 105 enters authentication data at the web client 110, which transmits the authentication data to Internet server 125. Internet server 125 passes the authentication data to authentication server which queries the user database 140 for corresponding credentials. When user 105 is authenticated, user 105 may access various applications and their corresponding data sources.

FIG. 2 shows a representative process for generating a list of recommended restaurants for a consumer. A consumer may be a user 105. A financial processor desires to recommend restaurants to consumers in order to increase consumer satisfaction and improve consumer loyalty. The financial processor collects data for use in generating relevant recommendations. In one embodiment, the data includes TXA data (Step 205). The data is used, for example, to analyze consumer attributes, to determine restaurants that the consumer may wish to visit and to evaluate the restaurants with respect to consumer attributes. For instance, the financial processor may use consumer account data, TXA data, marketing data, relationship management data, competitor data, government data, merchant rewards system data, third-party data, credit bureau data, geographic information data, census bureau data, TXA data from other financial processors, TXA data from merchants and/or any other data source that provides direct or indirect information on a consumer.

Referring now to FIG. 3, RLE 147 processes data and stores information regarding consumer attributes. In one embodiment, RLE 147 analyzes TXA activity to derive consumer attributes (Step 305). For instance, one relevant attribute for generating a recommendation may be an indication of the consumer's spending power. In one embodiment, consumer spending power may be determined over previous periods of time (sometimes referred to herein as the consumer's size of wallet or “SoW”) by using TXA data and other tradeline data sources. The share of wallet by tradeline or account type may also be determined. The SoW is represented by a consumer's or business' total aggregate spending and the share of wallet represents how the consumer uses different payment instruments. Methods and apparatus for calculating the size of wallet have been disclosed in U.S. patent application Ser. No. 11/169,588 which was published with publication number 2006-0242046 A1, the disclosure of which is hereby incorporated by reference in its entirety. Other examples of consumer attributes include transaction account data, transaction account type, transaction account spending amount, transaction account spending frequency, transaction account payment history, patronage frequency, size of wallet, consumer age, occupation, race, gender, profession, home location, business location, home zip code, business zip code, location of past transactions, time of transactions, number of children, type of home, number of children, marital status, product preference, merchant class preference, merchant sub-class preference, past patronage from merchant class, and credit score.

Similar to the consumer attribute derivation process, RLE 147 also processes data and stores information regarding merchant attributes (Step 310). The merchant attributes may include factual data or data based upon inference or some forecasting model. For instance, one relevant attribute is expert review or ranking of a restaurant that may be obtained from a third-party data source. In one embodiment, expert reviews are combined into a composite review score and stored as a merchant attribute. In one embodiment, the consumer attribute data (Step 305) is used to infer restaurant patronage behavior for a particular restaurant and/or a particular class of restaurants. Other examples of merchant attributes include product type, service type, merchant class, reputation, product delivery method, service delivery method, expert rating, consumer rating, TXA consumer rating, location, schedule, consumer spending amount, consumer spending frequency, type of consumer, merchant age, merchant facility type, merchant facility age, merchant facility décor.

The system incorporates a vast array of both consumer and merchant attributes used in generating the recommendation. Many recommendation techniques rely upon less sophisticated attributes, such as items viewed by a user on a e-commerce web site, items purchased, consumer reviews and feedback or search criteria entered by the consumer. RLE 147 accounts for both user attributes and restaurant attributes in deriving recommendations. In one embodiment, RLE 147 incorporates a holistic view of spending habits and assesses comprehensive demographic attributes, while also forming intelligent inferences of restaurant behavior based upon transaction history and other relevant data.

Referring again to FIG. 3, in the illustrated embodiment, consumers are clustered depending upon the amount of TXA data available for each consumer. For instance, if there is a large amount of TXA history available for the target consumer (such consumers are often known as “high-share” consumers), that consumer may be assigned clusters based upon one distance metric (Step 315). RLE 147 computes association weights between members within each cluster (Step 325). In one embodiment, a separate association weight is computed between the target consumer (the consumer for whom the recommendations are being produced) and all, or a subset, of the other consumers that are a member of one of the target consumer's cluster. RLE 147 computes the relevancy score for each consumer-restaurant combination (Step 330). In one embodiment, the relevancy score is a function of the association weights combined with the restaurant patronage behavior of each consumer in the target consumer's cluster.

If there is not a large amount of TXA data available for the target consumer (such consumers are often known as “low-share” consumers), a simple distance function technique may produce inaccurate or otherwise undesirable clusters. As practitioners will appreciate, this problem is related to the cold-start problem often encountered by cluster models. For solutions that rely upon direct input by or factual data related to a consumer, modeling a new consumer that lacks relevant data or transaction history is challenging. In one embodiment, the problem presented by low-share consumers is partially or fully solved by creating a specialized distance function and performing “look-alike” mapping (Step 335) based upon inferences derived from other consumer attributes to associate a low-share consumer with an appropriate set of high-share clusters (as determined in Step 325). For instance, a low-share consumer's restaurant patronage preferences may be inferred to resemble the preferences of a high-share consumer if the two consumers show a high correlation among other demographic or income attributes. In one embodiment, for example, a low-share consumer may be associated with a high-share cluster if the low-share consumer tends to prefer high-end entertainment options or if the low-share consumer tends to travel frequently. RLE 147 computes an enhanced popular score based upon look-alike mapping (Step 340).

Returning now to the representative embodiment shown in FIG. 2, RLE 147 uses relevancy scores for high share customers (calculated in step 330, FIG. 3) and enhanced popular scores for low share customers (calculated in step 340, FIG. 3) to rank the remaining restaurants for the high share customers (Step 213). RLE 147 takes negative exclusions into account (Step 215). For instance, if a restaurant has a particularly bad rating from a restaurant critic or if the restaurant received a health-code violation, a negative exclusion may eliminate the restaurant from the list of candidate restaurants to include in the recommendation. Similarly, RLE 147 may filter out restaurants that have already been patronized by the target consumer (Step 220). OPM 148 presents the recommendations to the target consumer (Step 230). In one embodiment, the recommendations are presented on a web page when a consumer visits the financial processor's web portal. However, practitioners will appreciate that the recommendations may be presented to the consumer using a variety of methods or a combination of several methods such as direct mail, email, consumer invoices, targeted marketing communications and the like. The consumer's reaction to the recommendations are measured by, for instance, clicking on the recommendation, making a reservation at a recommended restaurant, entering a restaurant rating or comment, and/or using the TXA at a restaurant. The reactions are gathered in a feedback loop for consideration in future recommendation processes (Step 235).

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

We claim:

1. A method for providing feedback to a target consumer based on transaction history, comprising:
analyzing consumer attributes which relate to target consumer attributes to create a target consumer cluster;
creating associations based upon merchant attributes and the target consumer attributes; and,
providing the feedback based on the associations.

2. The method of claim 1, wherein the creating associations step further comprises creating associations between the target consumer and a subset of consumers within the target consumer cluster.

3. The method of claim 1, further comprising obtaining target consumer attributes.

4. The method of claim 1, further comprising obtaining merchant attributes.

5. The method of claim 1, wherein the consumer attributes comprise at least one of:
transaction account data, transaction account type, transaction account spending amount, transaction account spending frequency, transaction account payment history, patronage frequency, size of wallet, consumer age, occupation, race, gender, profession, home location, business location, home zip code, business zip code, location of past transactions, time of transactions, number of children, type of home, number of children, marital status, product preference, merchant class preference, merchant sub-class preference, past patronage from merchant class, and credit score.

6. The method of claim 1, wherein creating a target consumer cluster comprises analyzing related and unrelated consumer attributes.

7. The method of claim 1, wherein the merchant attributes comprise at least one of:
product type, service type, merchant class, reputation, product delivery method, service delivery method, expert rating, consumer rating, location, schedule, consumer spending amount, consumer spending frequency, type of consumer, merchant age, merchant facility type, merchant facility age, merchant facility décor.

8. The method of claim 1, wherein the merchant attributes relate to restaurant attributes.

9. The method of claim 1, wherein analyzing consumer attributes using distance function metrics.

10. The method of claim 1, wherein analyzing consumer attributes comprises:
creating clusters using a first distance metric for high-share consumers;
creating clusters using a second distance metric for low-share consumers; and
mapping low-share consumers to high-share look alike clusters.

11. The method of claim 1, wherein providing feedback is based upon a relevancy score.

12. The method of claim 1, wherein the target consumer cluster comprises association weights between each consumer within the target consumer cluster.

13. The method of claim 1, further comprising calculating a relevancy score for combinations of the target consumer and a merchant.

14. The method of claim 1, wherein the feedback is provided using at least one of: direct mail, email, consumer invoices, targeted marketing, and transaction account statement.

15. The method of claim 1, wherein the feedback is further based on negative exclusions.

16. A machine-readable medium having stored thereon a plurality of instructions for providing feedback to a target consumer based on transaction history, the plurality of instructions when executed by a processor, cause the processor to perform the steps of:
analyzing consumer attributes which relate to target consumer attributes to create a target consumer cluster;
creating associations based upon merchant attributes and the target consumer attributes; and,
providing the feedback based on the associations.

17. A system for providing feedback to a target consumer based on transaction history comprising:
a rules engine configured to analyze consumer attributes which relate to target consumer attributes to create a target consumer cluster;
the rules engine further configured to create associations based upon merchant attributes and the target consumer attributes; and
an offer presentment module configured to provide the feedback based on the associations.
